(19) United States
(12) Patent Application Publication
(10) Pub. No.: US 2003/0175441 A1
(43) Pub. Date: Sep. 18, 2003

(54) Apparatus and method for coating through holes of printed wiring boards with fluid

(76) Inventor: Roger F. Bernards, South Haven, MN (US)

Correspondence Address: McAndrews, Held & Malloy, Ltd., 34th Floor, 500 West Madison Street, Chicago, IL, 60661, US

(21) Appl. No.: 10/095,643

(22) Filed: Mar. 12, 2002

(51) Int. Cl. B05D 1/28

(52) U.S. Cl. 427/428; 118/244

(57) ABSTRACT

An apparatus and method for applying a fluid to the through holes, vias, or other recesses of a printed wiring board is disclosed. The apparatus is a roller assembly. The roller comprises a cover and an interior portion and is supported by a mounting. A fluid supply provides treatment fluid to the interior portion. A feed transports a board into contact with the roller. The method is carried out by transporting fluid to the interior portion of the roller. The fluid then passes from the interior portion to the cover. A board is transported into contact with the roller assembly. Upon contact with a board, the roller cover deforms so that it distributes fluid across the board and pushes the fluid into the board's recesses. The roller assembly quickly receives and coats printed wiring boards while penetrating and coating recesses with high aspect ratios using minimal amounts of treatment fluid.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present invention generally relates to an apparatus and a method for coating a substrate surface with a treatment fluid. More particularly, the present invention relates to an apparatus and method for coating the walls of through holes, vias, or other recesses of a printed wiring board with a fluid by forcing the fluid into the recesses.

Printed wiring boards usually have through holes, vias, or other recesses (all referred to as “through holes” in this specification and the claims) that run into or through the thickness of the board. The through hole walls of a printed wiring board often are coated with treatment solutions such as conductive graphite or carbon black dispersions. Coating the through hole walls can be difficult in instances where the printed wiring boards have through holes with large aspect ratios. The aspect ratio of a through hole is the ratio of the depth of the through hole to the diameter of the through hole. Therefore, the larger the through hole aspect ratio, the more difficult it is to completely coat the through hole wall with a treatment fluid.

One method of coating printed wiring board through hole walls is to dip the board into a bath of the treatment fluid. This process is time-consuming and expensive for two reasons. First, it takes several minutes to adequately dip each board. Secondly, the bath life is limited, so it must constantly be replenished, and disposing of it can be costly and wasteful. It should also be noted that simply placing the board in a bath does not mean that the through hole walls will be adequately coated. Air bubbles can form in the hole unless the fluid is forced through the through hole. A variation of the bath method, such as that found in U.S. Pat. No. 6,037,020, conveys the board through a bath of treatment fluid, optionally agitated by ultrasonic energy. While this method saves time and forces fluid into the through holes, it still requires a bath including a relatively large amount of fluid that must constantly be circulated, replaced, and disposed of properly.

Nozzles are also used to coat through hole walls with treatment fluid. Printed wiring boards can be conveyed past nozzles that spray the boards with treatment fluid. One problem with spray application is that the sprayed fluid may not enter all the through holes or completely coat all of the through hole walls

Similar to a nozzle system is a chamber like that used in U.S. Pat. No. 4,064,290 which receives a printed wiring board, saturates the board in a pressurized flow of treatment fluid, and then wipes the board clean as it is removed. This system has the major drawback of requiring a great deal of treatment fluid for each board. Even if the fluid is recycled for future boards, its life is limited because of the contaminants it may acquire after flowing through each board. Also, this process is time-consuming because each board must individually be placed in the flow chamber and then removed and placed in an erect position to dry.

Another method for treating through holes is described in U.S. Pat. Nos. 5,741,361 and 5,879,738. This method uses a roller assembly that is said to create a pressurized fluid wedge when a printed wiring board is conveyed over a roller within a shrouded liquid reservoir. The contact between the roller and the board is said to force a wedge of treatment fluid from the shroud up into the board's through holes. However, it is uncertain how well this design works in fully penetrating recesses with large aspect ratios.

### BRIEF SUMMARY OF THE INVENTION

The invention is an apparatus and method for applying a fluid to the through holes, vias, or other recesses of a printed wiring board. A printed wiring board having at least one recess is provided. Generally, the printed wiring board will have a plurality of recesses.

The apparatus for applying fluid to the recesses of a printed wiring board is a roller assembly. The roller comprises a cover and an interior portion. The roller is supported by a mounting alongside a feed, and the feed is used to transport a printed wiring board into contact with the roller. A fluid supply provides treatment fluid to the interior portion of the roller assembly. Optionally, a recirculating bath can be used as the fluid supply.

The method of the invention is carried out by transporting liquid to the interior portion of the roller from a fluid supply. The fluid passes from the interior portion of the roller to the cover of the roller. A printed wiring board is transported into contact with the roller cover. Upon contact with a printed wiring board, the roller cover is deformed, passing the fluid from the roller cover into the recesses of the printed wiring board.

The roller assembly according to the present invention quickly receives and coats a printed wiring board, and therefore avoids the time-consuming process of dipping the board into baths or transporting it into spray or flow chambers. The roller assembly successfully penetrates and coats recesses with high aspect ratios, but it does not require excessive amounts of treatment fluid for treating each board. The present invention also will keep treatment fluid properly agitated.

### BRIEF DESCRIPTION OF THE SEVERAL VIEWS OF THE DRAWING

FIG. 1 is a plan view of a printed wiring board with through holes passing through the board.

FIG. 2 is a section of the board of FIG. 1, taken along section line 2-2.

FIG. 3 is a diagrammatic side elevation of the liquid supply, conduit, and roller assembly arranged to treat a printed wiring board. The intervening wall of the liquid supply is cut away to reveal internal structure.

FIG. 4 is a front elevation of the downstream side of the roller assembly and a counter roller treating a printed wiring board.

FIG. 5 is a section of the roller assembly of FIG. 4, taken along section line 5-5.

### DETAILED DESCRIPTION OF THE INVENTION

While the invention will be described in connection with one or more preferred embodiments, it will be understood that the invention is not limited to those embodiments. On the contrary, the invention includes all alternatives, modifications, and equivalents as may be included within the spirit and scope of the appended claims.

The present invention can be used to coat the through holes, vias, and other recesses of a planar substrate with a treatment fluid. One specific use for the invention is to penetrate and coat the recesses of a printed wiring board with a conductive treatment fluid. Planar substrates used in the manufacture of printed circuit boards may be unclad dielectric, dielectric having copper cladding on one or both of its surfaces, and multi-layer structures having sequential layers of dielectric material and copper inner layers. To ensure conductivity between the two sides of a printed wiring board or through a series of circuit layers, holes or recesses are drilled or punched through the board, and then the walls of the holes are plated with metal.

However, prior to plating the through holes with metal, the initially nonconductive through hole walls need to be coated with a conductive fluid. Suitable treatment chemicals and other supplies for carrying out this invention are sold, for example, under the registered trademark “SHADOW”® by Electrochemicals Inc., Maple Plain, Minn. A detailed description of the process for electroplating a conductive metal layer to the surface of a nonconductive material involving pretreating the material with a carbon black dispersion and then a graphite dispersion can be found in U.S. Pat. Nos. 5,389,270; 5,476,580; 5,690,805; 5,725,807; 6,037,020; and 6,171,468. These patents are incorporated herein by reference in their entirety. See also U.S. Pat. No. 5,139,642.

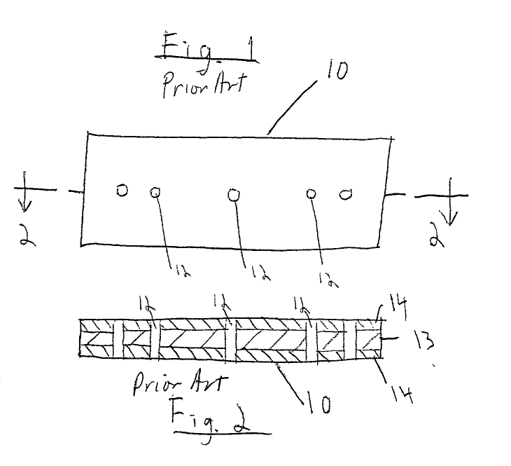

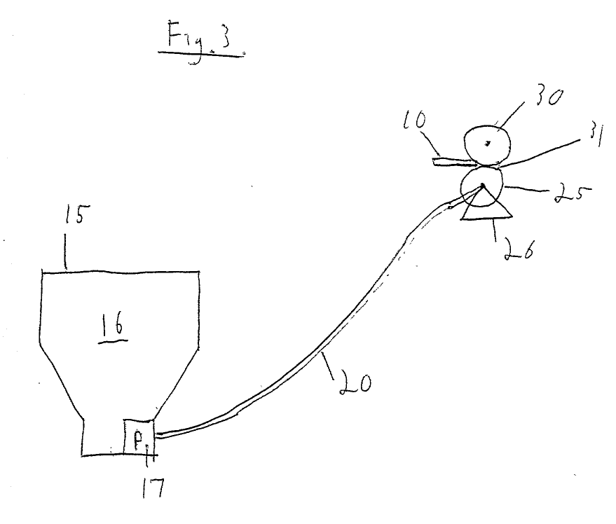

FIG. 1 provides a plan view of a printed wiring board 10. The printed wiring board 10 contains several recesses or through-holes 12. FIG. 2 is a cross-section of the printed wiring board 10 of FIG. 1 taken along section line 2-2. The printed wiring board 10 contains through holes 12 and comprises a dielectric layer 13 with copper plating 14 on both of its surfaces.

An overall view of the present invention for treating planar substrates is illustrated by FIG. 3. A liquid supply 15 contains a bath 16 of treatment liquid. The liquid supply 15 can be a recirculating bath as described in U.S. Pat. No. 6,037,020. A low-volume pump 17 is located in the liquid supply 15. A conduit 20 connects the pump 17 in the liquid supply 15 to the roller assembly 25. The roller assembly 25 is supported for rotation by a mounting 26. A counter roller 30 is located generally above the roller assembly 25. The counter roller 30 and the roller assembly 25 touch or nearly touch. The roller assembly 25 and the counter roller 30 form a nip 31. The nip 31 is used to hold a printed wiring board 10 between the roller assembly 25 and the counter roller 30. The roller assembly 25 and the counter roller 30 are desirably at least as wide as the printed wiring board 10.

FIG. 4 shows the roller assembly 25 and counter roller 30 from the front with a printed wiring board 10 in the nip 31. The counter roller 30 is attached to a shaft 32 by bearings 33. A motor 34 is attached to the shaft 32. The motor 34 rotates the counter roller 30 so as to create a feed into nip 31. The roller assembly 25 is attached by bearings 33 to a hollow shaft 35 connected to the conduit 20.

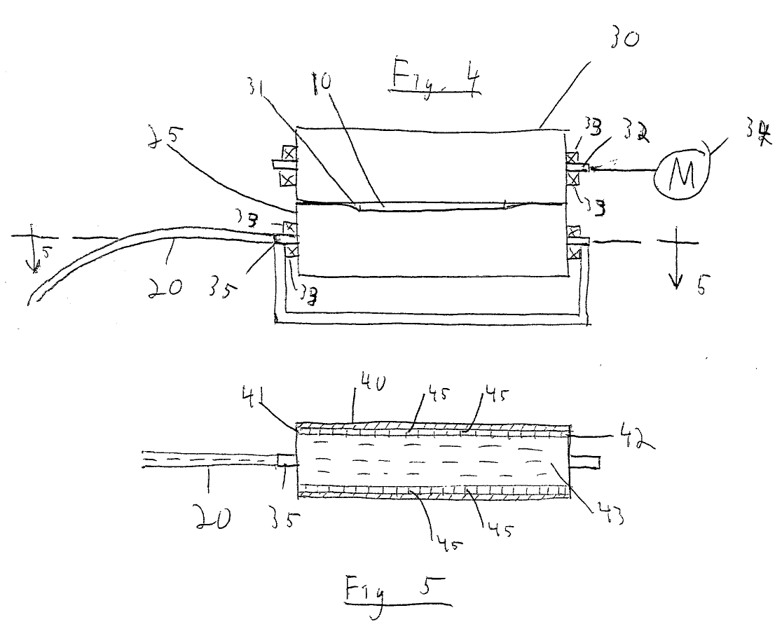

FIG. 5 is a cross-section of the roller assembly 25 of FIG. 4 taken along section line 5-5. Roller assembly 25 comprises a cover 40 and an interior portion 41. The roller cover 40 is made from a resilient, liquid-absorbing material such as foam plastic. More specifically, the cover 40 could be made from polyvinyl alcohol. The interior portion of the roller assembly 25 is defined by a wall 42 containing a hollow center 43, which holds treatment fluid received from the conduit 20 through the shaft 35. The wall 42 of the interior portion 41 contains several perforations 45.

Referring back to FIG. 3, the liquid supply 15 holds a treatment fluid bath 16 used to coat the through holes 12 of a printed wiring board 10. The liquid supply 15 can optionally be a recirculating bath that keeps dispersants in the treatment fluid from settling by constantly agitating the bath 16 of treatment fluid. The pump 17 located in the liquid supply 15 is used to push treatment fluid from the bath 16 through the conduit 20 and into the interior portion 41 of the roller assembly 25 via the roller shaft 35 as seen in FIG. 4. Once the treatment fluid has entered the interior portion 41 of the roller assembly 25, it flows throughout the hollow center 43 as seen in FIG. 5 and drains through the perforations 45 in the wall 42 of the interior portion 41 into the cover 40. The cover 40 then absorbs the treatment fluid.

The motor 34 shown in FIG. 4 causes the counter roller 30 to rotate, which in turn causes the roller assembly 25 to rotate. The feed produced by these rotations delivers a printed wiring board 10 generally horizontally into the nip 31 and thus into rolling contact with the roller assembly 25. As the board 10 passes above and contacts the roller assembly 25, the weight of the printed wiring board 10 and the pressure created by its presence in the nip 31 deform the cover 40 so that the cover 40 distributes treatment fluid across the surface of the printed wiring board 10 and pushes the treatment fluid into the board's through holes 12. Therefore, the roller assembly 25 coats the walls of the through holes 12 of the printed wiring board 10 before the board 10 is pushed out of the nip 31.

The present invention as illustrated in FIGS. 3-5 only requires the use of one roller assembly 25 located below a passing printed wiring board 10. However, the roller assembly 25 can be used in several different alignments. For example, a number of roller assemblies 25 could be arranged next to each other to form a series. One or more of the roller assemblies 25 could be driven to form a conveyor of roller assemblies 25 that provides several coatings for every passing printed wiring board 10. Likewise, the motor-powered roller assemblies 25 could be aligned in a series where some are located below the passing board 10 and some are located above the passing board 10. These roller assemblies 25 could be aligned alternately above and below, or in direct vertical alignment. An alternating vertical alignment would be a way to efficiently coat both sides of a board without having treatments above and below the board 10 interfere with each other. Another advantage of having roller assemblies 25 above and below the board is the ability to coat the walls of blind vias on both sides of the board 10. All of the different embodiments could include the use of counter rollers 30 as well so that passing boards 10 would place greater pressure on the roller assemblies 25 and thus produce better coatings. Other variations will readily occur to a person skilled in the art of printed wiring boards and are contemplated for use with this invention.

What is claimed is:

1. An apparatus for applying a liquid to the recesses of a printed wiring board, comprising:
A. a roller comprising a cover and an interior portion;
B. a mounting supporting said roller for rotation;
C. a liquid supply for providing liquid to said interior portion; and
D. a feed for feeding a printed wiring board in contact with said roller cover.

2. The apparatus of claim 1, further comprising a liquid recirculating bath, wherein said liquid supply is adapted to transport a liquid to said interior portion from said recirculating bath.

3. The apparatus of claim 1, wherein said cover is made from a resilient, liquid-absorbing material.

4. The apparatus of claim 1, wherein said cover is made from foamed plastic.

5. The apparatus of claim 4, wherein said plastic is polyvinyl alcohol.

6. The apparatus of claim 1, further comprising a wall defining said interior portion.

7. The apparatus of claim 6, wherein perforations are provided in said wall to allow for the transfer of liquid from said interior portion to said cover.

8. The apparatus of claim 1, wherein said cover is adapted to absorb liquid.

9. The apparatus of claim 1, further comprising a counter roller, wherein said counter roller forms a nip with said roller.

10. The apparatus of claim 1, wherein said nip receives a printed wiring board from said feed.

11. The apparatus of claim 1, wherein said feed directs the printed wiring board generally horizontally into said nip.

12. The apparatus of claim 1 wherein said counter roller is positioned above said roller.

13. The apparatus of claim 9, wherein said nip is adapted to deform said cover when passing a printed wiring board over said cover.

14. A method for applying a liquid to the recesses of a printed wiring board, comprising:
A. providing a printed wiring board having a major surface including a plurality of recesses;
B. transporting said printed wiring board into rolling contact with a roller comprising a cover and an interior portion, said rolling contact deforming said roller cover against said printed wiring board;
C. providing said liquid to said interior portion of said roller; and
D. passing said liquid from said interior portion of said roller to said cover and from said cover into said recesses; thereby forcing said liquid into said recesses of said printed wiring board.

15. The method of claim 14, further comprising providing said liquid from a liquid recirculating bath.

16. The method of claim 14, wherein said cover is made from a resilient, liquid-absorbing material.

17. The method of claim 14, wherein said cover is made from foamed plastic.

18. The method of claim 14, wherein said interior portion is defined by a wall.

19. The method of claim 14, wherein said wall is perforated to pass said liquid from said interior portion to said cover.

20. The apparatus of claim 14, wherein said cover absorbs said liquid that passes from said interior portion to said cover.

21. The method of claim 14, further comprising positioning a counter roller to form a nip with said roller cover, wherein said nip receives said printed wiring board.

22. The method of claim 14, wherein said printed wiring board is generally horizontal during said rolling contact.

23. The method of claim 14, wherein said printed wiring board passes above said cover and contacts said cover.

24. The method of claim 14, further comprising the step of deforming said cover during said rolling contact, thereby pushing said liquid into said recesses in said printed wiring board.
